(19) United States
(12) Patent Application Publication
(10) Pub. No.: US 2025/0016865 A1
(43) Pub. Date: Jan. 9, 2025

(54) A CONTROL METHOD FOR NON-DISRUPTIVE SW UPGRADE IN LIVE 5G RADIO ACCESS NETWORKS

(71) Applicant: Nokia Technologies Oy, Espoo (FI)

(72) Inventors: Jan Peter HELLSTRÖM, Espoo (FI); Janne Velkko KAASALAINEN, Espoo (FI)

(21) Appl. No.: 18/710,977

(22) PCT Filed: Nov. 14, 2022
(86) PCT No.: PCT/EP2022/081724

§ 371 Date: May 16, 2024

Related U.S. Application Data
(60) Provisional application No. 63/287,809, filed on Dec. 9, 2021.

(51) Int. Cl. H04W 76/19; H04W 8/22; H04W 24/02

(52) U.S. Cl. CPC H04W 76/19; H04W 8/22; H04W 24/02

(57) ABSTRACT

A method of operating a user equipment (UE) includes A receiving, from a first network element including a control plane node, a first message indicating that a control plane service provided by the control plane node has stopped; receiving a first indication that a conditional resume function of the UE has been activated; receiving a second message indicating that the control plane service has resumed; and based on the first indication, in response to the second message, performing the conditional resume function by sending, to the first network element, a first request to reconnect to the control plane node.

### TECHNICAL FIELD

One or more example embodiments relate generally to wireless communications and, more specifically, to facilitating positioning in Third Generation Partnership Project (3GPP) Fifth Generation (5G) New Radio (NR) networks.

### BACKGROUND

Fifth generation (5G) and 6^{th} generation (6G) wireless communications networks are the next generations of mobile communications networks. Standards for 5G communications networks are currently being developed by the Third Generation Partnership Project (3GPP). These standards are known as 3GPP New Radio (NR) standards. One area of development in 3GPP New Radio (NR), as well as with other relevant standard bodies (European Telecommunications Standards Institute (ETSI), Open Radio Access Network (O-RAN), Open Network Automation Platform (ONAP)) that specify the 5G data plane services, network functions and infrastructure resources management (operations support system (OSS)/business support system (BSS)) and orchestration (e.g., network function virtualization (NFV) orchestration (NFVO)), is control plane software (SW) maintenance (e.g., update, upgrade, rollback, etc.) procedures.

### SUMMARY

According to at least some example embodiments, a method of operating a user equipment (UE) includes receiving, from a first network element including a control plane node, a first message indicating that a control plane service provided by the control plane node has stopped; receiving a first indication that a conditional resume function of the UE has been activated; receiving a second message indicating that the control plane service has resumed; and based on the first indication, in response to the second message, performing the conditional resume function by sending, to the first network element, a first request to reconnect to the control plane node.

The method may further include after receiving the first message and before receiving the second message, continuing one or more existing uplink (UL) and/or downlink (DL) transmissions of user plane data between the UE and the first network element using at least one user plane service provided by at least one user plane node of the first network element.

The first network element may be a next generation node B (gNB) or a distributed unit (DU) of a gNB.

According to at least some example embodiments, a method of operating a user equipment (UE) includes receiving, from a first network element including a control plane node, a first message indicating that a control plane service provided by the control plane node has stopped, the UE being attached to a first cell associated with the first network element and the control plane node; receiving a first indication that a conditional redirection function of the UE has been activated; based on the first indication, determining, based on first redirection conditions, whether to perform a redirection operation; and in response to determining to perform the redirection operation, performing the conditional redirection function by attaching to a second cell different from the first cell.

The determining may include determining, based on the first redirection conditions, whether the UE requires access to a control plane service.

According to at least some example embodiments, a method of operating a network element including a control plane node includes receiving, from a first UE, a UE capability message indicating that the first UE is capable of performing a conditional resume function; sending, to the first UE, a first message indicating that a control plane service provided by the control plane node has stopped; activating the conditional resume function at the first UE by sending the first UE a first indication that the conditional resume function of the UE has been activated; sending, to the first UE, a second message indicating that the control plane service has resumed; and receiving, from the first UE, a request to reconnect the first UE to the control plane node.

The method may further include after sending the first message and before sending the second message, continuing one or more existing uplink (UL) and/or downlink (DL) transmissions of user plane data between the network element and the first UE using at least one user plane service provided by at least one user plane node included in the network element.

The network element may be a next generation node B (gNB) or a distributed unit (DU) of a gNB.

According to at least some example embodiments, a method of operating a network element including a control plane node includes receiving, from a first UE, a UE capability message indicating that the first UE is capable of performing a conditional redirection function, the first UE being attached to a first cell associated with the network element and the control plane node, the conditional redirection function including the first UE attaching to a second cell different than the first cell, sending, to the first UE, a first message indicating that a control plane service provided by the control plane node has stopped; and activating the conditional redirection function at the first UE by sending the first UE a first indication that the conditional redirection function of the UE has been activated.

The method may further include sending, to the first UE, first redirection conditions for performing a redirection function at the first UE.

According to at least some example embodiments, a method of operating a next generation Node B (gNB)-distributed unit (DU) of a gNB incudes sending a configuration update message to a gNB-central unit (CU) of the gNB, the configuration update message including a first transport network layer association (TNLA) identity (ID) and a first TNLA status; and receiving, from the gNB-CU, a configuration update acknowledgement message.

The first TNLA status may indicate whether a first TNLA is enabled or disabled, the first TNLA being a TNLA corresponding to the first TNLA ID.

The first TNLA status may indicate that the first TNLA is disabled, and the configuration update message may further include rebalancing rules indicating a manner in which the gNB-CU is to rebalance UE signaling that is associated with the first TNLA.

According to at least some example embodiments, a method of operating a next generation Node B (gNB)-central unit (CU) of a gNB includes receiving a configuration update message from a gNB-distributed unit (DU) of the gNB, the configuration update message including a first transport network layer association (TNLA) identity (ID) and a first TNLA status; and based on the first TLNA ID and the first TNLA status, releasing user equipment (UE) signaling that is associated with a first TNLA, the first TNLA being a TNLA corresponding to the first TNLA ID.

The configuration update message may further include rebalancing rules, and the method may further include rebalancing the UE signaling to other TNLAs based on the rebalancing rules.

According to at least some example embodiments, a user equipment (UE) includes memory storing computer-executable instructions; and a processor configured to execute the computer-executable instructions, wherein the computer-executable instructions include receiving, from a first network element including a control plane node, a first message indicating that a control plane service provided by the control plane node has stopped; receiving a first indication that a conditional resume function of the UE has been activated; receiving a second message indicating that the control plane service has resumed; and based on the first indication, in response to the second message, performing the conditional resume function by sending, to the first network element, a first request to reconnect to the control plane node.

The instructions may further include after receiving the first message and before receiving the second message, continuing one or more existing uplink (UL) and/or downlink (DL) transmissions between the UE and the first network element using at least one user plane service provided by at least one user plane node of the first network element.

The first network element may be a next generation node B (gNB) or a distributed unit (DU) of a gNB.

According to at least some example embodiments, a UE includes memory storing computer-executable instructions; and a processor configured to execute the computer-executable instructions, wherein the computer-executable instructions include receiving, from a first network element including a control plane node, a first message indicating that a control plane service provided by the control plane node has stopped, the UE being attached to a first cell associated with the first network element and the control plane node; receiving a first indication that a conditional redirection function of the UE has been activated; based on the first indication, determining, based on first redirection conditions, whether to perform a redirection operation; and in response to determining to perform the redirection operation, performing the conditional redirection function by attaching to a second cell different from the first cell.

The determining may include determining, based on the first redirection conditions, whether the UE requires access to a control plane service.

According to at least some example embodiments, a network element includes memory storing computer-executable instructions; and a processor configured to execute the computer-executable instructions, wherein the computer-executable instructions include receiving, from a first UE, a UE capability message indicating that the first UE is capable of performing a conditional resume function; sending, to the first UE, a first message indicating that a control plane service provided by a control plane node of the network element has stopped; activating the conditional resume function at the first UE by sending the first UE a first indication that the conditional resume function of the UE has been activated; sending, to the first UE, a second message indicating that the control plane service has resumed; and receiving, from the first UE, a request to reconnect the first UE to the control plane node.

The instructions may further include after sending the first message and before sending the second message, continuing one or more existing uplink (UL) and/or downlink (DL) transmissions between the network element and the first UE using at least one user plane service provided by at least one user plane node included in the network element.

The network element may be a distributed unit (DU) of a next generation node B (gNB).

According to at least some example embodiments, a network element may include memory storing computer-executable instructions; and a processor configured to execute the computer-executable instructions, wherein the computer-executable instructions include receiving, from a first UE, a UE capability message indicating that the first UE is capable of performing a conditional redirection function, the first UE being attached to a first cell associated with the network element and a control plane node of the network element, the conditional redirection function including the first UE attaching to a second cell different than the first cell, sending, to the first UE, a first message indicating that a control plane service provided by the control plane node has stopped; and activating the conditional redirection function at the first UE by sending the first UE a first indication that the conditional redirection function of the UE has been activated.

The instructions may further include sending, to the first UE, first redirection conditions for performing a redirection function at the first UE.

According to at least some example embodiments, a next generation Node B (gNB)-distributed unit (DU) of a gNB includes memory storing computer-executable instructions; and a processor configured to execute the computer-executable instructions, wherein the computer-executable instructions include sending a configuration update message to a gNB-central unit (CU) of the gNB, the configuration update message including a first transport network layer association (TNLA) identity (ID) and a first TNLA status; and receiving, from the gNB-CU, a configuration update acknowledgement message.

The first TNLA status may indicate whether a first TNLA is enabled or disabled, the first TNLA being a TNLA corresponding to the first TNLA ID.

The first TNLA status may indicates that the first TNLA is disabled, and the configuration update message may further include rebalancing rules indicating a manner in which the gNB-CU is to rebalance UE signaling that is associated with the first TNLA.

According to at least some example embodiments, a next generation Node B (gNB)-central unit (CU) of a gNB includes memory storing computer-executable instructions; and a processor configured to execute the computer-executable instructions, wherein the computer-executable instructions include receiving a configuration update message from a gNB-distributed unit (DU) of the gNB, the configuration update message including a first transport network layer association (TNLA) identity (ID) and a first TNLA status; and based on the first TLNA ID and the first TNLA status, releasing user equipment (UE) signaling that is associated with a first TNLA, the first TNLA being a TNLA corresponding to the first TNLA ID.

The configuration update message may further include rebalancing rules, and the instructions may further include rebalancing the UE signaling to other TNLAs based on the rebalancing rules.

According to at least some example embodiments, a user equipment (UE) includes receiving means for receiving, from a first network element including a control plane node, a first message indicating that a control plane service provided by the control plane node has stopped, receiving a first indication that a conditional resume function of the UE has been activated, and receiving a second message indicating that the control plane service has resumed; and conditional resume means for, based on the first indication, in response to the second message, performing the conditional resume function by sending, to the first network element, a first request to reconnect to the control plane node.

According to at least some example embodiments, a UE includes receiving means for receiving, from a first network element including a control plane node, a first message indicating that a control plane service provided by the control plane node has stopped, the UE being attached to a first cell associated with the first network element and the control plane node, and receiving a first indication that a conditional redirection function of the UE has been activated; determining means for, based on the first indication, determining, based on first redirection conditions, whether to perform a redirection operation; and conditional redirection means for, in response to determining to perform the redirection operation, performing the conditional redirection function by attaching to a second cell different from the first cell.

According to at least some example embodiments, a network element includes receiving means for, receiving, from a first UE, a UE capability message indicating that the first UE is capable of performing a conditional resume function, sending, to the first UE, a first message indicating that a control plane service provided by a control plane node of the network element has stopped, and receiving, from the first UE, a request to reconnect the first UE to the control plane node; activating means for activating means for activating the conditional resume function at the first UE by sending the first UE a first indication that the conditional resume function of the UE has been activated; and sending means for sending means for sending, to the first UE, a second message indicating that the control plane service has resumed.

According to at least some example embodiments, a network element includes receiving means for receiving, from a first UE, a UE capability message indicating that the first UE is capable of performing a conditional redirection function, the first UE being attached to a first cell associated with the network element and a control plane node of the network element, the conditional redirection function including the first UE attaching to a second cell different than the first cell; sending means for sending, to the first UE, a first message indicating that a control plane service provided by the control plane node has stopped; and activating means for activating the conditional redirection function at the first UE by sending the first UE a first indication that the conditional redirection function of the UE has been activated.

According to at least some example embodiments, a next generation Node B (gNB)-distributed unit (DU) of a gNB includes sending means for sending a configuration update message to a gNB-central unit (CU) of the gNB, the configuration update message including a first transport network layer association (TNLA) identity (ID) and a first TNLA status; and receiving means for receiving, from the gNB-CU, a configuration update acknowledgement message.

According to at least some example embodiments, a next generation Node B (gNB)-central unit (CU) of a gNB includes receiving means for receiving a configuration update message from a gNB-distributed unit (DU) of the gNB, the configuration update message including a first transport network layer association (TNLA) identity (ID) and a first TNLA status; and releasing means for, based on the first TLNA ID and the first TNLA status, releasing user equipment (UE) signaling that is associated with a first TNLA, the first TNLA being a TNLA corresponding to the first TNLA ID.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of this disclosure.

FIG. 1 is a diagram illustrating a portion of a wireless communications system according to at least some example embodiments.

FIG. 2 illustrates a network element according to at least some example embodiments.

FIG. 3 is a diagram illustrating an example of a conventional 3^{rd} generation partnership project (3GPP) Fifth Generation (5G) new radio (NR) radio resource control (RRC) connection re-establishment operation.

FIG. 4A is a signal timing diagram for explaining example methods of facilitating a non-disruptive software upgrade, according to at least some example embodiments.

FIG. 4B is a signal timing diagram for explaining example conditional UE redirection operations according to at least some example embodiments.

FIGS. 5A and 5B are diagrams for explaining an example of user equipment (UE) pre-configuration for C-plane SW upgrade or fault recovery scenarios, according to at least some example embodiments.

FIGS. 6A-6B are diagrams for explaining a conditional UE redirection operation, according to at least some example embodiments.

FIG. 7 is a diagram illustrating an example of a conventional 3GPP 5G NR next generation node B (gNB)-distributed unit (DU) configuration update procedure.

FIG. 8 is a signal timing diagram for explaining a method of configuring a DU, according to at least some example embodiments.

FIG. 9A is a diagram for explaining an example of network preparation for a control plane (C-plane) computer software (SW) upgrade, according to at least some example embodiments.

FIG. 9B is a diagram for explaining an example of activating a C-plane computer SW upgrade, according to at least some example embodiments.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

Various example embodiments will now be described more fully with reference to the accompanying drawings in which some example embodiments are shown.

Detailed illustrative embodiments are disclosed herein. However, specific structural and functional details and their naming conventions disclosed herein are merely representative for purposes of describing example embodiments. The example embodiments may, however, be embodied in many alternate forms and should not be construed as limited to only the embodiments set forth herein.

It should be understood that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

### 1. Overview of New Radio (NR) Control Plane (C-Plane) Software (SW) Maintenance

The 5G radio access network (RAN) is expected to provide highly available and highly reliable radio access service on 24/7/365 basis. For example, it would be desirable for 5G service to be provided with, for example, minimum 99.999% availability, which does not tolerate gNB service cumulative downtime exceeding 5 min 16s a year. 5G introduces differentiated network services (e.g., enhanced mobile broadband (eMBB), ultra-reliable low latency communications (URLLC), and massive machine type communications (mMTC)) as network slices that are subject of contextual service management and are to be provided with a specific service level agreement to support e.g., critical communication applications.

At the same times, 5G network operators may desire more frequent and smaller software (SW) releases of new feature upgrades and maintenance updates where only a smaller portion of the system services and capacity at a time is intended to be subject to change without interrupting the 5G service continuity or without compromising its performance. A conventional SW upgrade practice where planned service down time and scheduled SW maintenance windows are used may not be acceptable, given that the SW upgrades can cause the undesirable publicity and communications service provider (CSP) business image deteriorating service outages when measured by:
duration of the outage;
number of people or systems affected; and/or
cost of the outage.

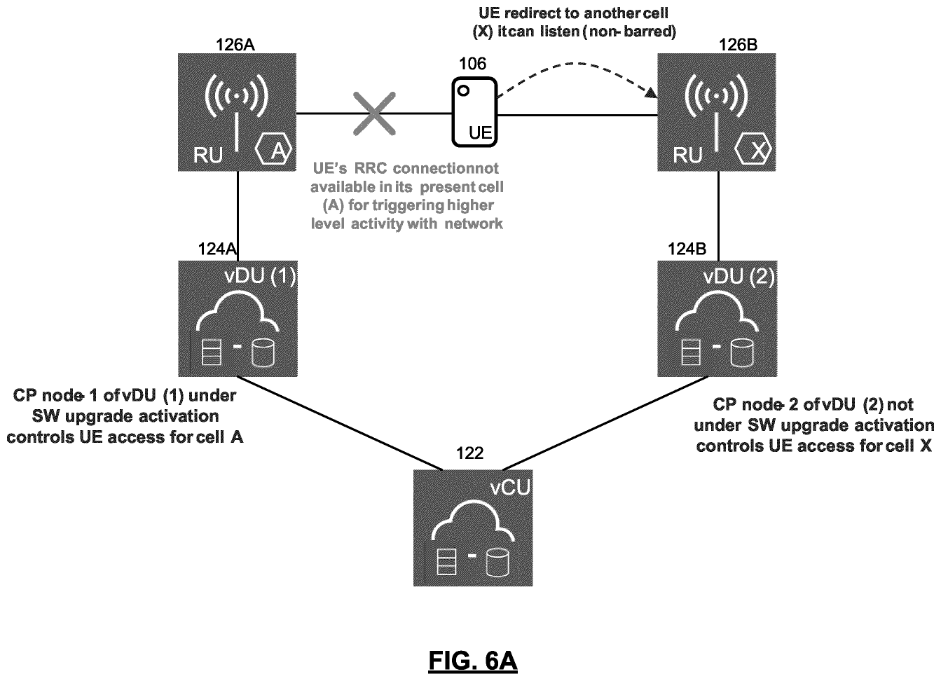

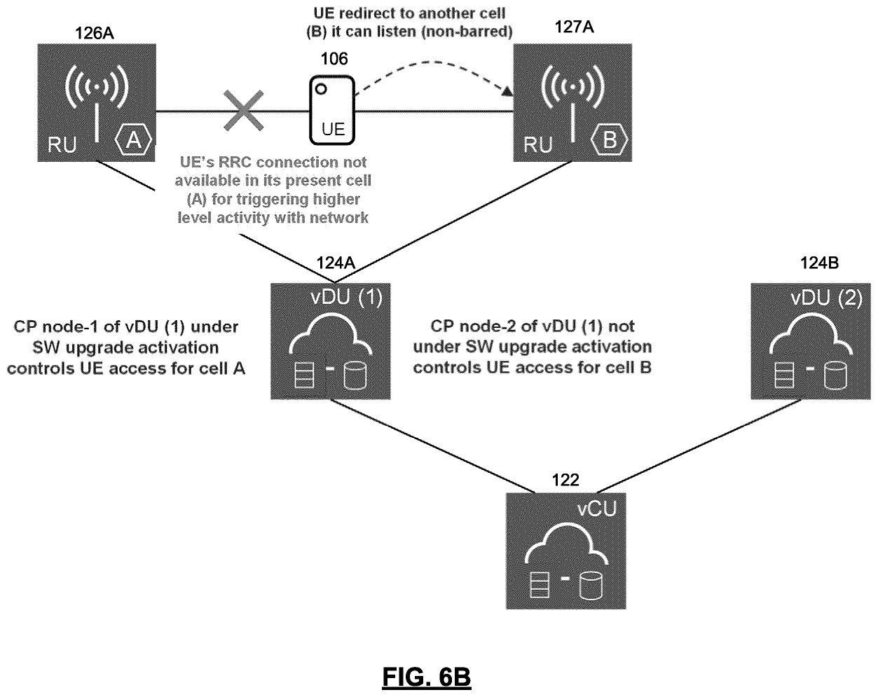

A 5G communications service provider (CSP) (e.g., a 5G CSP using and/or operating a next generation—radio access network (NG-RAN) described in 3GPP technical specification (TS) 38.401 v. 15.2.0, for example, by FIGS. 6A-6B.1-1) may desire that the cloud native gNB—central unit—control plane (gNB-CU-CP) cloud-native containerized network functions (CNF), gNB-CU—user plane (gNB-CU-UP) and gNB—distributed unit (gNB-DU) CNF deployment Life Cycle Management (LCM) operations healing/scaling/upgrade are performed gracefully and safely while in service, ensuring 5G service uninterrupted continuity and a non-degraded user experience. An example architecture explaining relationships between a gNB-CU-CP, gNB-CU-UP and gNB-DUs is provided in 3GPP TS 38.401 v. 15.2.0, for example, by FIGS. 6A-6B.1.2-1. The entire contents of 3GPP TS 38.401 v. 15.2.0 are incorporated, herein, by reference. Automated SW deployment processes may be employed with the goal of having less human intervention or no intervention at all, and may make use of non-disruptive and low-risk “blue-green”, “rolling” or “canary” SW deployment principles, where upon 5G CSPs themselves set upgrade policies by which only a portion of a gNB's service capacity is under SW modification at one time.

Examples of the SW modifications include:
Software update: E.g., a minor software modification process for bug fixes, patches, enhancements or other maintenance without adding, modifying or removing functionality, interfaces or protocols.
Software upgrade: E.g., a major software modification process aimed at adding new functionality, interfaces or protocols; modifying existing functionality, interfaces or protocols; or removing obsolete functionality, interfaces or protocols of as product features.
Software rollback: E.g., software modification process that reverts the system from the newly deployed software version back to the previously deployed software version.

To meet challenging time to market demands, DevOps practices are introduced for accelerating the Continuous integration (CI) and Continuous Delivery/Deployment (CD) phases in the SW release pipeline. CI produces automated SW build creation and testing of code changes that significantly reduces the number of code iterations and time spent with testing/debugging. Continuous Delivery provides more regular and smaller production ready SW builds for new feature upgrades or urgent SW maintenance updates that can be faster and independently deployed to production during normal business hours, without impacting service users. Explicit user approval is still needed to take the SW build into production. Continuous Deployment then targets fully automated delivery of SW builds to live (in theory within minutes from freezing the code and assuming it passed all automated test phases) without explicit user approval needed.

2. Issues with Stopping C-Plane Services During Software (SW) Maintenance

Next generation node B (gNB) SW modifications (e.g., update/upgrade) may be made effective in the nodes that deploy C-plane services, by activating the new SW version container images to replace the old SW version container images presently running. The activation is done, for example:
by rebooting a physical computer unit of physical network function (PNF) deployment;
by restarting a virtual machine (VM)-based cloud computer unit virtualized network function component (VNFC) of a virtualized network function (VNF) deployment; and/or
by deleting/recreating a pod of a containerized application of a cloud-native containerized network function (CNF) deployment,
   which may then then be followed by starting 5G application binary images of a new SW version. The ungraceful stopping of C-plane services in their nodes arbitrarily and without preparation may disrupt the behavior of the gNB and prevent the gNB from producing correct outputs at its external interfaces, and may even make the gNB prone to service outage.

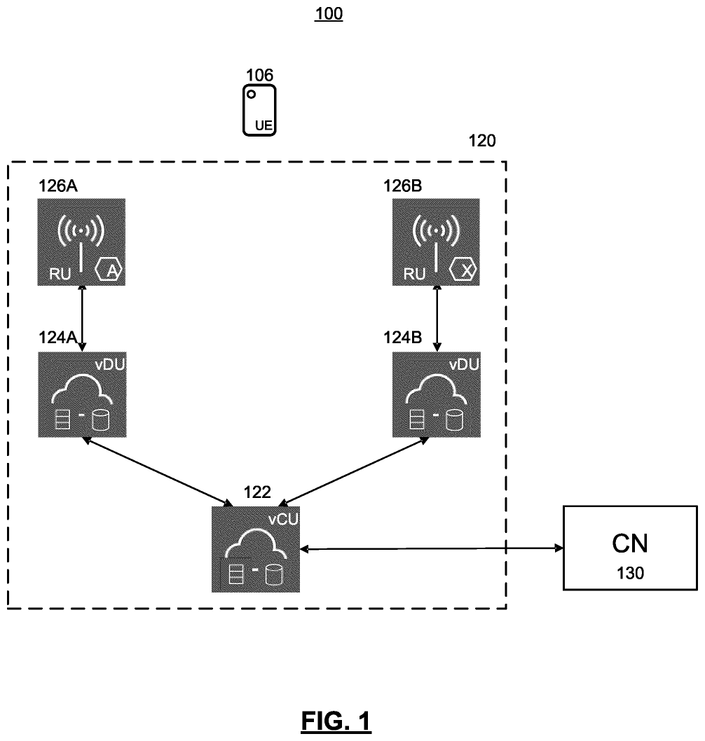

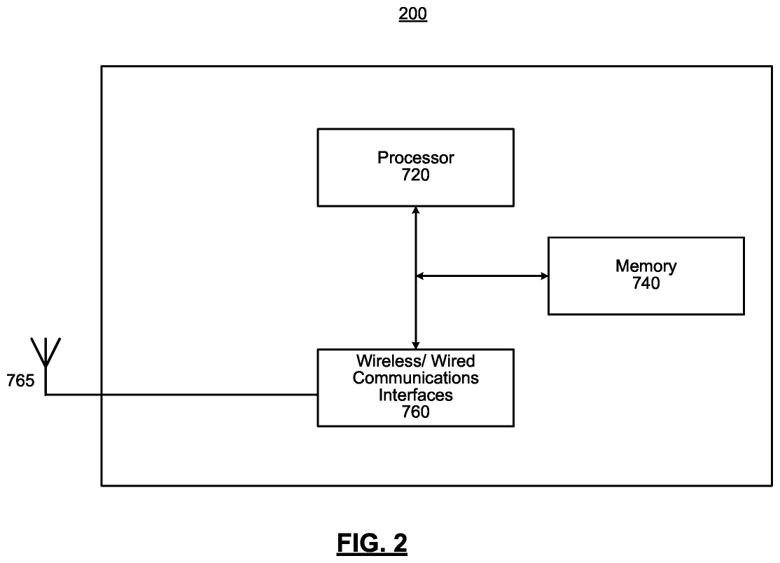

Examples of an architecture of a wireless communications network and a structure of a network element, according to at least some example embodiments, will now be discussed below with reference to FIGS. 1 and 2.

### 3. Example Architecture of a Wireless Communications System and an Example Structure of a Network Element Thereof.

FIG. 1 illustrates a simplified diagram of a portion of a 3rd Generation Partnership Project (3GPP) New Radio (NR) access deployment for explaining example embodiments in more detail.

Referring to FIG. 1, wireless communications system 100 is an example of a 3GPP NR radio access deployment and includes a gNB 120. According to at least some example embodiments, the wireless communications system 100 may have the structure of the overall architecture of next generation —radio access network (NG-RAN) described in 3GPP technical specification (TS) 38.401 v. 15.2.0, for example, by FIGS. 6.1-1. The entire contents of 3GPP TS 38.401 v. 15.2.0 have been incorporated by reference. As is illustrated in FIG. 1, the gNB 120 may have a central unit 122, multiple distributed units (DUs) (e.g., first DU 124A and second DU 124B) and multiple radio units (e.g., first RU 124A and second RU 124B). In the example illustrated in FIG. 1, the CU 122 is connected to the first DU 12A and the second DU 124B, the first RU 126 A is connected to the first DU 124A, and the second RU 126B is connected to the second DU 124B. According to at least some example embodiments, the CU 122 may be connected to each of the first and second DUs 124A and 124B via an F1 interface. According to at least some example embodiments, each RU may include, for example, a radio frequency (RF) antenna (or antennas) or antenna panels, and a radio transceiver, for transmitting and receiving data. In this regard, the gNB 120 provides cellular resources for user equipment (UEs) (e.g., first UE 106) within a geographical coverage area of the gNB 120, for example, via the RUs (e.g., first and second RUs 126A and 126B). The CU 122 may also be referred to as a gNB-CU and/or vCU. Each of the first and second DUs 124A and 124B may also be referred to as a gNB-DU and/or vDU. Each of the first and second RUs 126A and 126B may also be referred to as a remote radio unit (RRU).

In some cases, baseband processing may be divided between the CU 122, DUs 124A and 124B and RUs 126A and 126B in a 5th Generation (5G) cell. Alternatively, the baseband processing may be performed at the CU 122 or at the CU 122 and the DUs 124A and 124B. The gNB 120 is configured to communicate with UEs within its coverage area via the RUs of the gNB 120, and each RU of the gNB 120 can communicate with UEs (e.g., uplink (UL) and downlink (DL) transmissions) via one or more transmit (TX)/receive (RX) beam pairs. Further, the gNB 120 communicates with the core network (CN) 130, which is referred to as the New Core or 5G core (5GC) in 3GPP NR.

Although, for the purpose of simplicity, only a single UEs (i.e., first UE 106) is shown in FIG. 1, the gNB 102 may provide communication services to multiple UEs (e.g., a relatively large number of UEs) within the coverage area of the gNB 102.

Example functionality and operation of the first UE 106 be discussed in more detail below. Examples of devices which may embody the first UE 106 include, but are not limited to, a mobile device, a stationary customer premises equipment (CPE), a tablet, a laptop computer, a wearable device, an Internet of Things (IoT) device, a desktop computer and/or any other type of stationary or portable device capable of operating according to the 5G NR communication standard, and/or other wireless communication standard.

According to at least some example embodiments, the wireless communications system 100 is not limited to the elements illustrated in FIG. 1 and the wireless communications system 100 may include numbers of constituent elements different than those shown in FIG. 1. For example, the wireless communications system 100 may include any number of UE devices, any number of gNBs, etc.

Additionally, though not illustrated, the CN 130 may include a number of 5GC network elements. For example, the gNB 120 may be connected to a location management function (LMF), an access and mobility management function (AMF) element and/or a session management function (SMF) element. Additionally, though not illustrated, the wireless communications system 100 may further include long-term evolution (LTE) network elements or 6^{th} generation radio access technology elements that are connected to the gNB 120. Examples of such LTE elements include, but are not limited to, LTE radio access technology (RAT) network elements (e.g., evolved universal mobile telecommunications system (UMTS) terrestrial radio access network (E-UTRAN) network elements) such as evolved node Bs (eNBs), and LTE core network elements (e.g., evolved packet core (EPC) network elements) such as mobility management entities (MMEs). An example structure which may be used to embody one or more radio network elements (e.g., gNBs, UEs, etc.) of the wireless communications system 100 will now be discussed below with respect to FIG. 2.

FIG. 2 illustrates an example embodiment of a network element. Referring to FIG. 2, a network element 200 includes: a memory 740, a processor 720, and various communications interfaces 760 connected to each other; and one or more antennas or antenna panels 765 connected to the various communications interfaces 760. The various interfaces 760 and the antenna 765 may constitute a transceiver for transmitting/receiving data to/from a UE, a gNB, a CN node, a CN element, and/or another radio network element via one or more of a plurality of wireless beams. According to at least some example embodiments, in addition to, or alternatively, instead of, including interfaces for supporting wireless communications, various interfaces 760 may include interfaces for supporting wired communications.

As will be appreciated, depending on the implementation of the network element 200, the network element 200 may include many more components than those shown in FIG. 2 for providing the functionalities of the particular element of the wireless communications system 100 being embodied by the network element 200 (e.g., functionalities of a UE, a CN element, a gNB, etc. in accordance with one or more example embodiments). However, it is not necessary that all of these generally conventional components be shown in order to disclose the illustrative example embodiment.

The memory 740 may be a computer readable storage medium that generally includes a random access memory (RAM), read only memory (ROM), and/or a permanent mass storage device, such as a disk drive. The memory 740 also stores an operating system and any other routines/modules/applications for providing the functionalities of the particular element of the wireless communications system 100 being embodied by the network element 200 (e.g., functionalities of a UE, a CN element and/or node, a gNB, etc. in accordance with one or more example embodiments) to be executed by the processor 720. These software components may also be loaded from a separate computer readable storage medium into the memory 740 using a drive mechanism (not shown). Such separate computer readable storage medium may include a disc, tape, DVD/CD-ROM drive, memory card, or other like computer readable storage medium (not shown). In some example embodiments, software components may be loaded into the memory 740 via one of the various interfaces 760, rather than via a computer readable storage medium. According to at least some example embodiments, the memory 740 may store computer-executable instructions corresponding to any or all steps discussed with reference to FIGS. 1-9B.

The processor 720 may be configured to carry out instructions of a computer program by performing the arithmetical, logical, and input/output operations of the system. Instructions may be provided to the processor 720 by the memory 740.

The various interfaces 760 may include components that interface the processor 720 with the one or more antennas 765, or other input/output components. As will be understood, the various interfaces 760 and programs stored in the memory 740 to set forth the special purpose functionalities of the network element 200 will vary depending on the particular element of the wireless communications system 100 being embodied by the network element 200.

The various interfaces 760 may also include one or more user input devices (e.g., a keyboard, a keypad, a mouse, or the like) and user output devices (e.g., a display, a speaker, or the like).

Example methods for facilitating non-disruptive software (SW) upgrade procedures for 5G network elements will now be discussed below with reference to FIGS. 1-9B.

4. Example Methods for Facilitating Non-Disruptive Next Generation Node B (gNB) Software (SW) Upgrade Procedures for 5G Network Elements

As is noted above, the ungraceful stopping of C-plane services in their nodes arbitrarily and without preparation, e.g., during software upgrades of control plane (C-plane) nodes at DUs of a gNB, may disrupt the behavior of the gNB and prevent the gNB from producing correct outputs at its external interfaces, and may even make the gNB prone to service outage. Accordingly, it would be desirable to develop techniques for mitigating the disruptive effects associated with performing such SW upgrades.

Methods for facilitating non-disruptive gNB SW upgrades according to example embodiments may reduce or, alternatively eliminate the need for interrupting C-plane service throughout a stepwise C-plane SW upgrade process. Methods for facilitating non-disruptive gNB SW upgrades according to example embodiments may also reduce the C-plane SW upgrade disruption caused with respect to user plane (U-plane) service, for example, to minimal or none. According to at least some example embodiments, the SW upgrade operation contributed service down time can be reduced which mitigates the risk for total network outage caused by possible concurrently occurring fault events (the C-plane service redundancy level that ensures its High Availability is temporarily decreased during the activation of SW upgrade per C-plane node). In order to facilitate non-disruptive gNB SW releases, it may be desirable to amend 3GPP specifications for UE control (e.g., 3GPP technical specification (TS) 38.331 v 16.4.1), medium access control (MAC) protocol (e.g., 3GPP TS 38.321 v 16.4.0), and network procedure (e.g., 3GPP TS 38.473 v 16.5.0).

Methods for facilitating non-disruptive gNB SW upgrades according to example embodiments may create such gNB internal favorable preconditions for the high availability of C-plane services that, despite one C-plane node undergoing a SW update/upgrade operation, the end user 5G radio access service can still be continued seamlessly on other available redundant C-plane nodes. The non-disruptive SW update/upgrade operation may involve pre-work actions for preparing the C-plane node service for its upcoming stop/restart by, for example:
blocking further use of the C-plane in order to deny new UE context and user signaling connection creations during upgrade preparation;
passively draining it empty from existing active UE contexts and user signaling connections during upgrade preparation; and
actively live-migrating (rebalancing) the remaining existing UEs and their signaling connections to other C-plane nodes that during SW update/upgrade accept new service requests.

Thus, according to at least some example embodiments, the handling of SW upgrades while maintaining high availability of C-plane services may be transparent to gNB external 3GPP interfaces (e.g., NG-c, Xn-c, X2-c, F1-c, E1-c) serving active UE signaling connections.

Further, at least some example embodiments may provide the benefit of the gNB elasticity to flexibly match a 5G network traffic load volume and its variation by automatic scaling of cloud resources on-demand. For example, the scalable capacity gNB-CU or gNB-DU C-plane and U-plane services may typically have their own dedicated and independently scalable resources. At least some example embodiments may provide an opportunity to stop/restart high-availability C-plane service nodes arbitrarily while gNB is servicing, for example, for scale-in operation (capacity is decreased by removing a C-plane node) or just because they experience random failures, with little or no impact of U-plane services or concern of major key performance indicators (KPI) degradation. High capacity gNB-CUs and gNB-DUs may cover a bigger geographical 5G service area supporting high numbers of users and critical communication applications. Accordingly, it is advantageous to reduce or minimize service disruption with the aim to achieve or, alternatively, approach “zero downtime” with any life cycle management (LCM) operations, planned or unplanned.

Methods for facilitating non-disruptive gNB SW upgrades may include, for example, a conditional resume-based method, a conditional redirection-based method and/or a radio access network (RAN) preparation-based method. The conditional resume-based method, conditional redirection-based method and/or RAN preparation-based method can be used alone independently of each other or they can be used together to provide an improved or, alternatively, optimal solution. According to at least some example embodiments, the conditional resume-based method and conditional redirection-based method relate to pre-configurations of a UE for preparing the UE for a condition where its radio resource control (RRC) connection with a network is temporary unavailable during C-plane service SW upgrading or recovery. Using the conditional resume-based method and conditional redirection-based method together may add more control to the UE itself while the 5G network C-plane service becomes temporarily unresponsive, and may significantly improve the reliability and retainability of UE's radio access service in case the network entity undergoes planned or unplanned life cycle management (LCM) operations. The RAN preparation-based method may prepare the 5G RAN (e.g., gNB-CU and gNB-DU) itself for maintaining the UE's RRC connectivity during a C-plane service SW upgrade procedure.

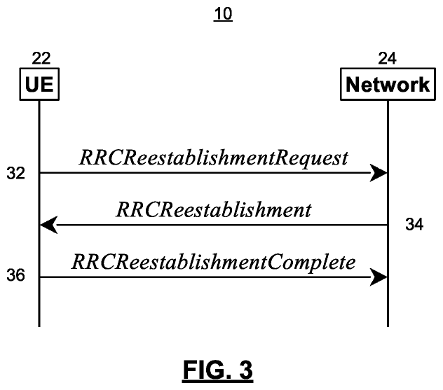

According to at least some example embodiments, the network resume-based method includes a new network controlled RRC and MAC level UE pre-configuration procedure to reduce or, alternative, minimize the UE's MAC scheduling stop period by sending a new UE message promptly when UE's RRC connection on SRB will be temporarily lost. New UE signaling which may be included in the network resume-based method will be discussed in greater detail below with reference to FIGS. 3-5B. According to at least some example embodiments, the network (e.g., gNB) pre-configures the UE for RRC suspend/resume operations. Further, the network (e.g., gNB) allows UEs in a cell of the gNB to still continue prior started downlink (DL) and uplink (UL) U-plane data transmission, in situations where network C-plane service (or an RRC entity providing the C-plane service) is not needed for maintaining the UE's radio access for user data transmission while a SW upgrade or recovery procedure is performed with respect to the network C-plane service.

According to at least some example embodiments, the network redirection-based method includes a new network controlled RRC and MAC level UE pre-configuration procedure to allow the UE, on its own initiation, to trigger conditional redirection to another 5G cell or to another radio access technology (RAT) cell it can detect in case higher layer activity is needed, e.g., for an emergency call while a C-plane service (or an RRC entity providing the C-plane service) is not available for the UE in the cell to which the UE is presently attached. New UE signaling which may be included in the network redirection-based method will be discussed in greater detail below with reference to FIGS. 3-4 and 6. According to at least some example embodiments, the network redirection-based method may ensure that the UE's radio access continuity can be retained if the UE needs to attach to a new cell when SW upgrade or fault recovery procedures is still in progress with respect to a C-plane node associated with a cell to which the UE is presently attached.

In the RAN preparation-based method, the RAN itself is prepared for maintaining the UE's RRC connectivity end to end supported by N+(all active) redundant C-plane service node resources and dynamic reconfiguration of multi-transport network layer associations (TNLAs), e.g., at an F1-C interface between the gNB-DU and gNB-CU. The invention describes how preparation for non-disruptive SW upgrade can be done with multi-TNLA configuration where each redundant C-plane node in a gNB-DU terminates its own scalable TNLA instance of an F1-C signaling link and where the independent multi-TNLAs can protect each other from unavailability/end point failure with respect to a single TNLA by mutually sharing a total UE signaling connection load on the F1-C signaling link.

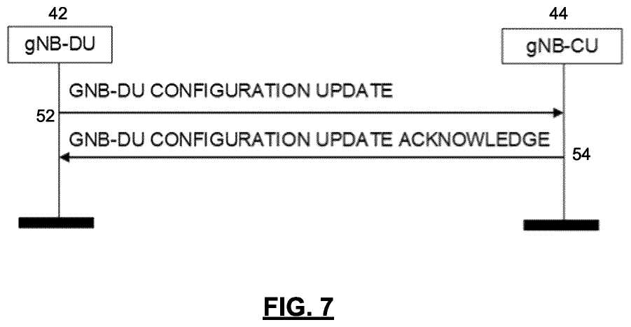

Now, according to at least some example embodiments, when scalable C-plane nodes will undergo an upcoming SW upgrade procedure or scaling operations (or may experience random node failures), it is possible to maintain F1-C link service for existing and new UE signaling connections with reduced or, alternatively, no traffic loss by preparing its TNLA up front for removal or for temporarily disabling its use. New network signaling associated with the RAN preparation-based method will be discussed in greater detail below with reference to FIGS. 7-9B. The same preparatory pre-configurations may be performed, for example, when a “blue green”, “rolling” or “canary” process is applied for upgrading the C-plane service nodes or their representing capacity portions (%) one by one.

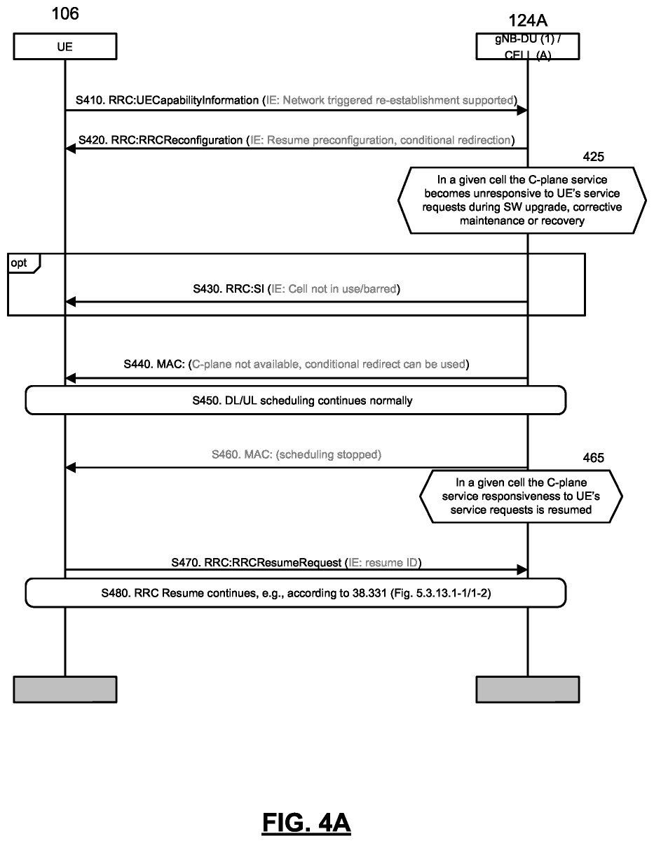

The conditional resume-based method and conditional redirection-based method for facilitating non-disruptive next generation node B (gNB) software (SW) upgrade procedures will now be discussed in greater detail, below, with reference to FIGS. 4-6.

5. Conditional Resume-Based Method and Conditional Redirection-Based Method Examples for Facilitating Non-Disruptive Next Generation Node B (gNB) Software (SW) Upgrade Procedures

FIG. 3 is a diagram illustrating an example of a conventional 3rd generation partnership project (3GPP) 5th generation (5G) new radio (NR) radio resource control (RRC) connection re-establishment operation.

The purpose of the procedure illustrated in FIG. 3 is to re-establish the RRC connection. For example, a UE 22 in RRC_CONNECTED, for which access stratum (AS) security has been activated with signaling radio bearer 2 (SRB2) and at least one data radio bearer (DRB) setup or, for integrated access and backhaul (IAB), SRB2, may initiate the procedure in order to continue the RRC connection. The connection re-establishment succeeds if a network 24 is able to find and verify a valid UE context or, if the UE context cannot be retrieved, and the network responds with an RRC Setup according to clause 5.3.3.4. of TS 38.331 v 16.4.1. As is illustrated in FIG. 3, the UE 22 sends an RRC reestablishment request 32, RRCReestablishmentRequest, to the network 24, the network 24 responds with an RRC reestablishment message 34, RRCReestablishment, and the UE 22 sends an RRC reestablishment completion message 36, RRCReestablishmentComplete, to the network 24.

Conventionally, when the UE 22 loses access to, or is left without the control of, a network RRC entity in the network 24, the UE 22 needs to detect that its radio frequency (RF) has been lost, and then attempt to send the RRC re-establishment request 32 to the network 24. In case the gNB-controlled cell of the network 24 to which the UE 22 was attached is still down, UE 22 may be forced to wait for the expiration of the UE 22's RRC timer before reselection to another cell is allowed. This can cause several seconds interruption time which can threaten UE communication service survivability. However, with the conditional resume-based method according to at least some example embodiments, the UE communication service down time may be limited to, for example, just few milliseconds.

For example, according to at least some example embodiments, the conditional resume-based method includes a new type of resume pre-configuration and activation procedure that may allow the UE data transmission interruption time to be reduced or, alternatively, eliminated.

According to at least some example embodiments, in the conditional resume-based method, a UE is preconfigured for RRC suspension and resuming. Thus, the UE is prepared for a C-plane node SW upgrade or other scenario (fault recovery) where the network C-plane service (or RRC entity, e.g., gNB-DU C-plane node, providing the C-plane service) becomes temporarily unavailable all the sudden. The conditional resume configuration shall be reactively activated by the network with MAC level functionality when the gNB detects that a particular C-plane node RRC entity handling UE signaling has problems. Once the UE has received an indication to activate a conditional resume function, the UE knows that the network is having problems that presently prevent the network from any further handling of higher level (higher than L2) functionality.

When the network C-plane service recovers and sets up RRC entity functionality again, the UE is notified, for example, using a MAC scheduling stopped message. When the UE receives scheduling stopped message, the UE responds by sending a message to the network for RRC resume with the configuration it presently has. Once the network RRC entity receives the UE's RRC resume request and identifies the UE from its prior stored UE context, the network RRC entity will proceed with the resume procedure normally as already specified by 3GPP.

With the conditional redirection-based method, the network can also preconfigure rules for specifying to the UE what it is allowed to do during network C-plane service (RRC entity) unavailability/unresponsiveness. Depending on UE-provided capability information, the network can configure conditional rules for the UE that it can apply when it needs to immediately trigger higher level activity with network e.g., UE redirection to other 5G cell or other RAT cell where higher level UE control is available (e.g., for establishing an emergency call) for the UE.

The conditional resume-based method and conditional redirection-based method will now be discussed in greater detail, below, with reference to FIGS. 4A-6. FIG. 4A is a signal timing diagram for explaining example methods of facilitating a non-disruptive software upgrade, according to at least some example embodiments. FIGS. 4A-4B will be explained with reference to the first UE 106, and the gNB 120 of the wireless communications network of FIG. 1. FIGS. 4A-4B illustrates new signaling (e.g., new information elements (IE)) associated with the conditional resume-based method and conditional redirection-based method for facilitating non-disruptive gNB software (SW) upgrade procedures according to at least some example embodiments.

Referring to FIG. 4A, in operation S410, the first UE 106 sends an RRC UE capability information message to the first gNB-DU 124A of the gNB 120. According to at least some example embodiments, the RRC UE capability information message (which may also be referred to as a UE capability message) may include capability information indicating whether the first UE 106 is capable of performing one or both of the conditional resume function and the conditional redirection function. According to at least some example embodiments, the UE capability message is, or includes, a new IE for providing the capability information.

In operation S420, the first gNB-DU 124A sends an RRC reconfiguration message to the first UE 106. According to at least some example embodiments, the first gNB-DU 124A uses the RRC reconfiguration message to configure the first UE 106 with the conditional resume function and/or with optional rules what to do in case higher layer functionality is needed (e.g., rules for performing the conditional redirection function) while the first UE 106 finds a network RRC entity (e.g., C-plane node) associated with a cell to which the first UE 106 was attached is non-responsive. This higher layer activity can relate, for example, to an emergency call that needs urgent handling. According to at least some example embodiments, at the point when operation S420 occurs, C-plane services have not yet become unavailable. Operation S420 serves as part of a preparation phase in which the network (e.g., first gNB-DU 124A) indicates that C-plane services may or will stop. According to at least some example embodiments, operation S420 can be performed any time (e.g., seconds or minutes) before C-plane services stop. Accordingly, during operation S420, the network (e.g., first gNB-DU 124A) provides each UE that is capable of performing the conditional resume function or conditional redirection function with rules for how to operate when C-plane services are not available, and thus, the capable UEs are able to perform the conditional resume and/or conditional redirection functions in case those functions are ever needed. According to at least some example embodiments, the rules provided during operation S420 may specify conditions under which capable UEs are to perform the conditional resume and/or conditional redirection functions.

A C-plane service unavailability event 425 may occur. The C-plane service unavailability event 425 may be, for example, the C-plane service becoming unresponsive to service requests of the UE 106 during a SW upgrade, corrective maintenance, or a recovery procedure. According to at least some example embodiments, when a C-plane service unavailability event 425 occurs, in operation S430, the first gNB-DU 124A may optionally send a message to the first UE 106 indicating that the cell with which the unavailable C-plane service is associated is not in use and/or indicating that the first UE 106 is barred from communicating with that cell.

According to at least some example embodiments, in operation S440, the first gNB-DU 124A sends a MAC scheduling command to the first UE 106. According to at least some example embodiments, the MAC scheduling command sent in operation S440 may be an indication to the UE 106 that there are C-plane availability issues with the cell of the first gNB-DU 124A to which the UE is attached (e.g., suspension of a C-plane service of a C-plane node associated with the cell for SW upgrade of fault recovery reasons). According to at least some example embodiments, the MAC scheduling command sent in operation S440 may further indicate to the UE 106 that a conditional resume function of the first UE 106 has been activated (i.e., the first UE 106 is authorized to perform the conditional resume function when the UE 106 determines that conditions for performing the conditional resume function have been met). According to at least some example embodiments, instead of, or in addition to, indicating the presence of issues at the cell and/or indicating activation of the conditional resume function, the MAC scheduling command sent in operation S440 may also include criteria for the UE performing the conditional redirection function. According to at least some example embodiments, the MAC scheduling message sent in operation S440 is, or includes, a new IE for providing any or all of an indication of the presence of issues at the cell, an indication to the first UE 106 that the conditional resume function has been activated, and criteria (e.g., conditions) for performing the conditional redirection function.

According to at least some example embodiments, in operation S450, the first UE 106 and the gNB 120 continue scheduling uplink (UL) and downlink (DL) transmissions, normally.

According to at least some example embodiments, in operation S460, the first gNB-DU 124A sends the first UE 106 a MAC message indicating that scheduling is stopped. According to at least some example embodiments, the MAC scheduling stopped message is sent by the first gNB-DU 124A in response to the gNB 120 (e.g., the first gNB-DU 124A) determining that the C-plane service which had been suspended (e.g., at event 425) is going to be resumed. For example, in event 465 the previously suspended C-plane service may become responsive (e.g., because a SW update procedure or fault recovery operation performed with respect to a C-plane node of the previously suspended C-plane service has been completed). According to at least some example embodiments, the MAC scheduling stop message is, or includes, a new IE for notifying the first UE that scheduling has stopped and/or triggering the UE to perform a conditional resume function.

According to at least some example embodiments, when the conditional resume function of the first UE 106 has been activated (e.g., in response to the MAC scheduling command received at the first UE 106 in operation S440), the first UE 106 may respond to the MAC message received in operation S460 by performing the conditional resume function. For example, in operation S470 the first UE may send an RRC resume request message to the gNB 120. According to at least some example embodiments, the RRC resume request may be an RRC reestablishment request RRCReestablishmentRequest that has been modified to include a new IE: a resume ID.

Accordingly, because the MAC scheduling stop message sent in operation S460 provides the gNB 120 with a way to tell the first UE 106 that a previously suspended C-pane function has been resumed, and the activation of the conditional resume function at the first UE allows the UE to decide to send an RRC reestablishment request in response to the MAC scheduling stop message, an amount of time spent before the UE 106 requests to reestablish an RRC connection to the C-plane node associated with the previously suspended C-plane service may be reduced.

In operation S480, the first UE 106 and the gNB 120 may continue to operate in accordance with the procedures provided by TS 38.331 v 16.4.1, the entire contents of which are incorporated herein by reference.

FIG. 4B is a signal timing diagram for explaining example conditional UE redirection operations according to at least some example embodiments.

Referring to FIG. 4B, operations S410-S450 may be the same as in FIG. 4A. Accordingly, descriptions of operations S410-S450 of will not be repeated.

After operation S450, a redirection operation may be performed. In the example illustrated in FIG. 4B, 2 different example redirection operations are illustrated: S660 and S670.

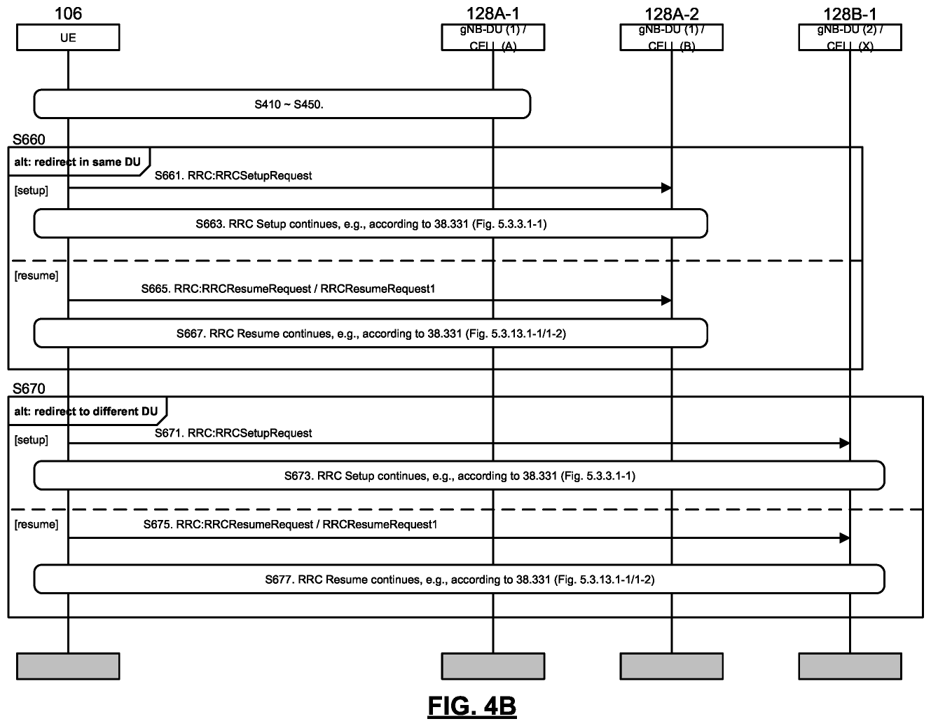

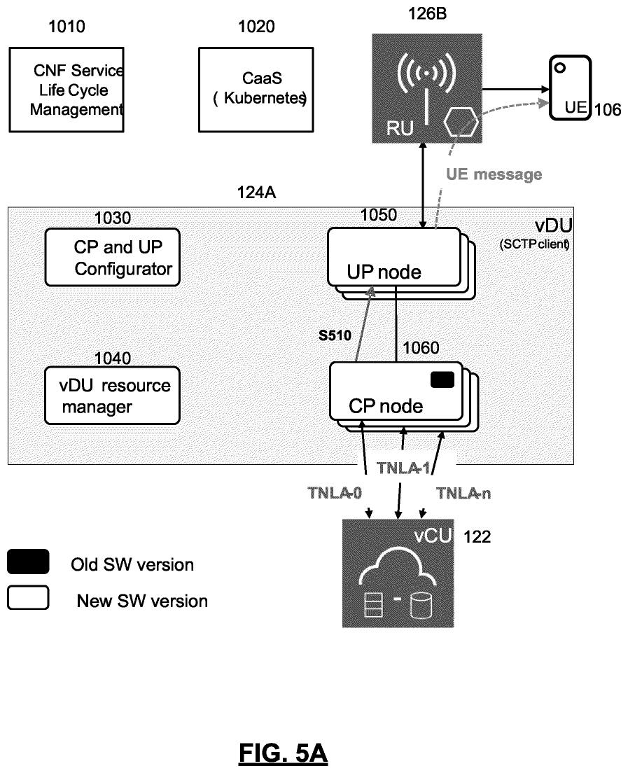

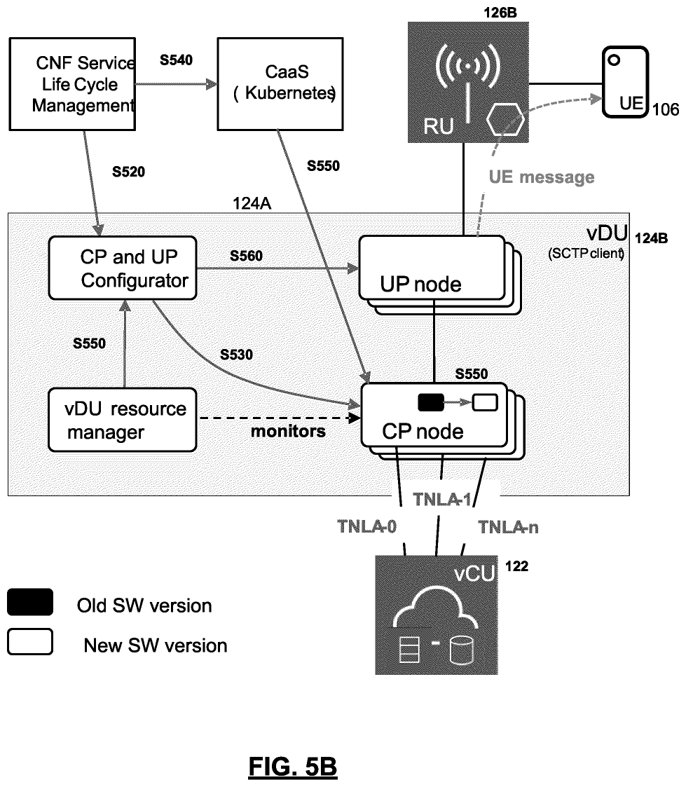

Operation S660 is a redirection operation involving 2 cells associated with the same gNB-DU. For example, redirection operation S660 may result in switching the UE 106 from being attached to a first cell 128A-1 associated with the first gNB-DU 124A to being attached to a second cell 128A-2 associated with the first gNB-DU 124A. Operation S660 may include a setup portion [setup] and a resume portion [resume]. Operation S660 includes operations S661-S667. In operation S661, the UE 106 sends an RRC setup request to the second cell 128A-2 associated with the first gNB-DU 124A. In operation S663, an RRC setup process continues in accordance with known methods (e.g., methods described in 3GPP TS 38.331, FIG. 5.3.3.1-1). In operation S665, the UE 106 sends an RRC resume request to the second cell 128A-2 associated with the first gNB-DU 124A. In operation S667, an RRC setup process continues in accordance with known methods (e.g., methods described in 3GPP TS 38.331, FIG. 5.3.13.1-1/1-2). As a result of redirection operation S660, the UE 106 may be redirected from the first cell 128A-1 of the first DU 124A to the second cell 128A-2 of the first DU 124A.

Operation S670 is a redirection operation involving 2 cells associated, respectively, with two different gNB-DUs. For example, redirection operation S670 may result in switching the UE 106 from being attached to the first cell 128A-1 associated with the first gNB-DU 124A to being attached to a first cell 128B-1 associated with the second gNB-DU 124B. Operation S670 may include a setup portion [setup] and a resume portion [resume]. Operation S670 includes operations S671-S677. In operation S671, the UE 106 sends an RRC setup request to the first cell 128B-1 associated with the second gNB-DU 124B. In operation S673, an RRC setup process continues in accordance with known methods (e.g., methods described in 3GPP TS 38.331, FIG. 5.3.3.1-1). In operation S675, the UE 106 sends an RRC resume request to the first cell 128B-1 associated with the second gNB-DU 124B. In operation S667, an RRC setup process continues in accordance with known methods (e.g., methods described in 3GPP TS 38.331, FIG. 5.3.13.1-1/1-2). As a result of redirection operation S670, the UE 106 may be redirected from the first cell 128A-1 of the first DU 124A to the first cell 128B-1 of the second DU 124B.

FIGS. 5A and 5B are diagrams for explaining an example of user equipment (UE) pre-configuration for C-plane SW upgrade or fault recovery scenarios, according to at least some example embodiments. FIGS. 6A-6B are diagrams for explaining a conditional UE redirection operation, according to at least some example embodiments.

FIG. 5A illustrates the gNB-CU 122, first gNB-DU 124A and first RU 126A of the gNB 120 of FIG. 1. FIG. 5A further illustrates a CNF life cycle management node 1010 and a communications as a service (CaaS) node 1020. According to at least some example embodiments, the CaaS node 1020 is a Kubernetes-based CaaS node. As is also illustrated in FIG. 5A, the first gNB-DU 124A may include a plurality of user plane (U-plane) nodes 1050, a plurality of C-plane nodes 1060, a C-plane (CP) and U-plane (UP) configurator 1030, and a vDU resource manager 1040. According to at least some example embodiments, the plurality of CP nodes 1060 may each, respectively, be connected to the gNB CU 122 through a corresponding transport network layer association (TNLA) from among first through nth TLNAs TLNA-1-TLNA-n.

FIG. 5B illustrates the same elements as FIG. 5A. Accordingly, for the purpose of simplicity, a duplicated explanation of the elements of FIG. 5B is omitted.

A method of performing pre-configuration for C-plane SW upgrade or fault recovery scenarios will now be explained with reference to FIGS. 5A and 5B.

As part of UE capability inquiry, an RRC connected first UE 106 sends a UE capability message UECapabilitylnformation (e.g., UE message 108A) to the network. In operation S510, a network RRC entity (e.g., the first DU 124A or one of CP nodes 1060 of the first DU 124A) can consequently preconfigure the first UE 106 for situations where the yyyyyy entity service becomes temporarily unavailable due to a planned SW upgrade or due to C-plane service fault recovery procedure. As is illustrated in FIG. 5A, according to at least some example embodiments, the preconfiguration of the first UE 108 in operation S510 may include a C-plane node (e.g., one of CP nodes 1060) sending a UE preconfiguration message (e.g., UE message 108B which may be, for example, an RRC reconfiguration message) to the first UE 106 via a U-plane node (e.g., one of UP nodes 1050). According to at least some example embodiments, two new pre-configurations can be enabled for the first UE 106 by an RRC reconfiguration message sent from the network to the first UE 106. According to at least some example embodiments, the RRC reconfiguration message sent to the first UE 106 in operation S510 of FIG. 5 corresponds to the RRC reconfiguration message sent to the first UE 106 in operation S420 of FIG. 4A.

With the conditional resume method according to at least some example embodiments, the first UE 106 may be preconfigured (e.g., by the RRC reconfiguration message) to perform the conditional resume function when a network MAC entity sends the MAC scheduling stopped message to the first UE 106. The network MAC entity may be, for example, a U-plane node from among the U-plane nodes 1050.

With the conditional redirection method according to at least some example embodiments, the first UE 106 may be preconfigured (e.g., by the RRC reconfiguration message) to perform the conditional redirection function, that allows UE redirection to another accessible 5G cell or a cell of another radio access technology (RAT), on the first UE 106's own initiation. The conditional redirection function may be advantageous, for example, when first UE 106 is about to lose radio access in its present cell.

In operation S520, the CNF service life cycle management node 1010 notifies the CP and UP configurator 1030 about the start of a C-plane SW update/upgrade operation according to an operator upgrade policy (e.g., a policy of an operator of the wireless network 100). Examples of an upgrade policy include, but are not limited to, one at a time, % of capacity, and all. According to at least some example embodiments, CP nodes that have been selected (e.g., from among the CP nodes 1060) to undergo a SW update procedure may be identified to CP and UP configurator 1030 (e.g., by the CNF service life cycle management node 1010).

In operation S530, the CP and UP configurator 1030 prepares the selected CP nodes for the SW upgrade procedure by configuring the selected CP nodes to deny servicing for new RRC connection requests from UEs.

In operation S540, the cloud-native network functions (CNF) Service Life Cycle Management node 1010 requests new SW version activation for the CP nodes 1060 from a CNF service orchestrator, e.g., the Kubernetes-based CaaS node 1020.

In operation S550, the CaaS node 1020 may consequently conduct the requested new SW version activation for selected ones of the CP nodes 1060 by restarting or recreating the selected CP nodes followed by the startup of new SW version container images. The vDU resource manager 1040 that monitors the availability of the CP nodes 1060 and the readiness of C-plane services it deploys may notify the CP and UP configurator 1030 of changes in the readiness of the CP nodes 1060. According to at least some example embodiments, after operation S550, the method of performing pre-configuration for C-plane SW upgrade or fault recovery scenarios according to at least some example embodiments may be the same for both no matter why the CP service was terminated (i.e., regardless of whether the C-plane service was suspended due to a SW upgrade procedure or a fault recovery procedure).

In operation S560, the CP and UP configurator 1030 may notify a U-plane node, from among U-plane nodes 1050, that at least one C-plane node (RRC) from among the C-plane nodes 1060 has become unavailable. According to at least some example embodiments, the first UE 106 can continue any current DL and/or UL data transmissions (e.g., using the U-plane nodes 1050), if the first UE 106 does not require higher level functionality provided by the C-plane.

The conditional redirection method according to at least some example embodiments will now be discussed in greater detail below with reference to FIGS. 6A-6B. FIGS. 6A-6B are diagrams for explaining a conditional UE redirection operation, according to at least some example embodiments.

Referring to FIG. 6A, in a scenario where the first UE 106 has been configured to perform a conditional redirection function (e.g., by the RRC Reconfiguration message sent from the gNB 120 to the first 106 in operation S420 of FIG. 4A), and the first UE 106 has determined that criteria for performing the redirection function have been met, the first UE 106 may perform a redirection function by detaching from a current cell and attaching to a new cell. In the example illustrated in FIG. 6A, the first UE 106 detaches from a cell associated with the first RU 126A and the first DU 124A and attaches to a cell associated with the second RU 126B and the second DU 124B. In the example illustrated in FIG. 6B, the first RU 126A and a third RU 127A are both RUs of the same DU, first DU 124A. Referring to FIG. 6B, the first UE 106 detaches from a cell associated with the first RU 126A and the first DU 124A and attaches to a cell associated with a third RU 127A and the first DU 124A. An example of criteria for performing the conditional redirection function may be criteria including criterion (A) and criterion (B): (A) a message (e.g., the MAC scheduling message sent in operation S440 of FIG. 4A) indicating that there are C-plane availability issues associated with the cell to which the first UE 106 is currently attached has been received at the first UE 106, and (B) the first UE 106 has determined that it requires access to higher level functionality provided by the C-plane. According to at least some example embodiments, the first UE 106 receives the criteria for performing the redirection function in an RRC reconfiguration message received from the gNB 120 (e.g., in step S420 of FIG. 4A). Additionally, or alternatively, according to at least some example embodiments, the first UE 106 receives the criteria for performing the redirection function in a MAC scheduling message received from the gNB 120 (e.g., in step S440 of FIG. 4A).

The RAN preparation-based method for facilitating non-disruptive gNB SW upgrade procedures will now be discussed in greater detail, below, with reference to FIGS. 7-9B.

6. Radio Access Network (RAN) Preparation-Based Method Examples for Facilitating Non-Disruptive Next Generation Node B (gNB) Software (SW) Upgrade Procedures

With the RAN preparation-based method according to at least some example embodiments, the network provides support for graceful handling of upcoming planned C-plane SW update/upgrade procedures (or capacity scaling) in a controlled way depending on a multi-TNLA configuration at F1-c signalling link between gNB-DU (subject of SW upgrade) and gNB-CU (not subject of SW upgrade). In this example the cloud native gNB-DU C-plane functionality is distributed into multiple C-plane service nodes of same or different types. A specific C-plane and U-plane service ‘configurator’ function co-ordinates the SW update/upgrade process (e.g., “rolling” upgrade) in its different phases.

According to at least some example embodiments, in order to scale gNB-DU capacity also for signaling transport at the F1-c interface, 3GPP TS 38.473 F1 application protocol (F1AP) v16.5.0, the entire contents of which are incorporated herein by reference, allows for the configuring of multiple F1-c signaling link transport associations (e.g., multi-TNLAs) to connect one individual gNB-DU (which may serve as a stream control transmission protocol (SCTP) client) with a gNB-CU (which may serve as an SCTP server), where a UE-associated signaling connection load can be balanced across multiple TNLAs. By the specification both gNB-DU and gNB-CU can upon increased C-plane node computing capacity demand scale additional TNLAs dynamically to be terminated to separate nodes.

A different method may be applied when the SCTP client (e.g., a gNB-DU) or SCTP server (e.g., a gNB-CU) adds the multi-TNLAs. The gNB-DU (e.g., the client) can test whether the gNB-CU (e.g., the server) supports multiple TNLAs by sending an SCTP INIT update from a different IP endpoint address to the gNB-CU, whereas the gNB-CU (e.g., the server) can initiate TNLA addition by sending a CU configuration update message for requesting the gNB-DU to initiate SCTP connection creation with respect to a new SCTP port number and destination IP address. Once the SCTP connections for TNLAs have been established at both end points, the gNB-DU and gNB-CU can share the UE signaling connection load across multiple C-plane computing units that terminate the F1-c TNLAs.

Now assuming the above mentioned multi-TNLA configuration is in use for the F1-c interface and the gNB-DU has a scalable (e.g., redundant) C-plane computer units configured for matching the gNB-DU's present C-plane capacity needs, it is then possible to activate C-plane SW update/upgrade procedures for individual C-plane computer units by restarting them one-by-one with new SW version code images without interrupting the gNB-DU service. While the SW upgrade is in progress the C-plane service continuity may be maintained in those C-plane computer units not presently under LCM operation. When supported by separation of C-plane service logic (SW) and C-plane service state (data), the existing UE signaling connections on the C-plane computer unit that is next subject of restart for new SW version activation will, or can, be moved (rebalanced) gracefully to other C-plane computers units as described in this invention. C-plane computer units may also be referred to, in the present specification, as CP nodes or C-plane nodes.

FIG. 7 is a diagram illustrating an example of a conventional 3GPP 5G NR next generation node B (gNB)-distributed unit (DU) configuration update procedure. As is illustrated in FIG. 7, a gNB-DU 42 sends a gNB-DU configuration update message 52 to a gNB-CU 44, and the gNB-CU 44 sends an acknowledgement message 54 (i.e., a gNB-DU configuration update acknowledgement message) back to the gNB-DU 42.

According to 3GPP TS 38.473 v 16.5.0, if the GNB-DU CONFIGURATION UPDATE message includes gNB-DU TNL Association To Remove List IE, and the Endpoint IP address IE and the Port Number IE for both transport network layer (TNL) endpoints of the TNL association(s) are included in the gNB-DU TNL Association To Remove List IE, the gNB-CU shall, if supported, consider that the TNL association(s) indicated by both received TNL endpoints will be removed by the gNB-DU. If the Endpoint IP address IE, or the Endpoint IP address IE and the Port Number IE for one or both of the TNL endpoints is included in the gNB-DU TNL Association To Remove List IE in GNB-DU CONFIGURATION UPDATE message, the gNB-CU shall, if supported, consider that the TNL association(s) indicated by the received endpoint IP address(es) will be removed by the gNB-DU according to 3GPP TS 38.473 v 16.5.0.

In the current multiple TNLA specification, the gNB-DU can only remove (e.g., delete) a TNLA to indicate to the gNB-CU that the TNLA is not available anymore, which can be disruptive for UEs that were using the unavailable TNLA. The way how the gNB-CU, from there onward, would use the remaining TNLAs is not specified by 3GPP. This arbitrariness and ambiguity with respect to TNLA load rebalancing may cause an unexpected sudden traffic load increase in random gNB-DU C-plane computing units (e.g., CP nodes) which may lead to an overload in at least one of the CP nodes and cause unnecessary key performance indicator (KPI) degradation, or even unit failure. Conventionally, the purpose of the removal operation of an individual multi-TNLA is, for example, handling a changed network load condition where, due to a permanently decreased traffic load (or a long-term traffic load decrease), one TNLA is not needed anymore for TNLA load sharing, thus justifying its removal. The gNB-DU can balance the gNB-CU destined UE signaling connection load selectively per TNLA and force the gNB-CU to use different a TNLA, but this is applicable only for the existing UEs. If the gNB-CU triggers new UE signaling connection establishment, conventionally, there is no way to prevent the gNB-CU from arbitrarily using any of the available F1-C interface TNLAs for the new UE.

For at least the above-referenced reasons, it would be advantageous not to ungracefully remove a scalable multi-TNLA instance without a pre-warning that availability of the multi-TNLA instance will soon to be impacted by an upcoming C-plane computer unit restart necessitated by its planned but non-urgent life cycle management (LCM) operation. In order to improve upon the 3GPP multi-TNLA specification, the RAN network-preparation method according to at least some example embodiments includes a way to add more control in the gNB-DU (e.g., as a SCTP client) for preparing the inevitable TNLA load rebalancing needed when one gNB-CU and gNB-DU mutual multi-instance TNLA use is disabled by the gNB-DU.

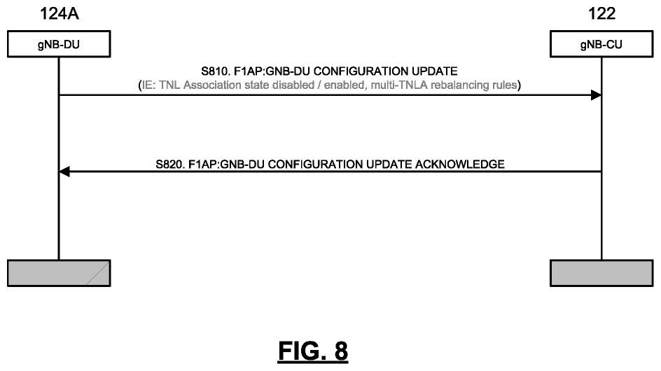

For example, FIG. 8 is a signal timing diagram for explaining a method of configuring a DU, according to at least some example embodiments. Referring to FIG. 8, in operation S810, the first gNB-DU 124A may send a, FlAP GNB-DU configuration update message to the gNB-CU 122. Further, the gNB-CU 122 may response by sending an FlAP gNB-DU configuration update acknowledgement message to the first gNB-DU 124A.

Referring to FIG. 8, according to at least some example embodiments, instead of removing a TNLA without preparation or at all, the gNB-DU 124A may use a DU configuration update procedure with a new IE added for indicating the TNLA's present resource state, either ‘enabled’ or ‘disabled’, where state=‘disabled’ is used for indicating to gNB-CU 122 that this TNLA ID's further use for active services shall be denied (e.g. for an upcoming LCM operation soon to be started, or for one that already is in progress for the C-plane computer unit). For example, the gNB-DU configuration update message sent by the first gNB-DU 124A in operation S810 may include the aforementioned new IE. After receipt of the DU configuration update message, the gNB-CU 122 may stop immediately using that TNLA ID any longer for existing or new UE signaling connections, yet still keeping the TNLA connected with the gNB-DU 124A as a standby resource. The TNLA state change from ‘enabled’ to ‘disabled’ does not necessarily involve any shutdown phase since the gNB-DU TNLA load balancer can, in a preparation phase, block its use for new signaling connections and drain it to idle.

To avoid the arbitrariness and ambiguity with respect to how the gNB-CU 122 will respond to the ‘disabled’ state TNLA that it must forcefully empty from all UEs, this invention presents another new IE for the same DU configuration update procedure that is purposed to set updated rules for the gNB-CU 122 how it shall to (re)balance the F1-C link UE signaling connections out of the ‘disabled’ state TNLA id. The rebalancing rules may allow UEs to be distributed, e.g., across all active TNLAs or just use a specific one as target. Thus, with the RAN-preparation method the F1-C link load rebalancing can be fully controlled and configured by the gNB-DU 124A with one DU configuration update message be exchanged between the gNB-DU 124A and the gNB-CU 11.

When the preparatory actions for a planned and non-urgent C-plane computer unit LCM operation are completed and there is readiness to restart the C-plane computer unit without any concern of active UE service disruption or discontinuity, there are then two possible approaches to handle the TNLA context during restart, depending on the level of resiliency level of the C-plane service:
1. A non-resilient C-plane F1 application protocol (F1AP) service in the gNB-DU 124A can remove the TNLA controlled way at the end of the preparation phase when all the gNB-DU's existing UE signaling connections are released or rebalanced to other TNLAs. When a TNLA is removed, the gNB-DU 124A may confirm its readiness to the gNB-DU CNF service life cycle management node 1010 that can then immediately proceed to activate the SW upgrade for that C-plane node. If the TNLA is not removed in a controlled manner by the gNB-DU 124A, the gNB-CU 122 will close the TNLA eventually by itself based on detecting an F1-C link failure. Once the C-plane computer unit is restarted with new version SW, the gNB-DU 124A can add a new multi-TNLA instance (state=‘enabled’) in it for sharing F1-C link load.
2. A resilient C-plane FlAP service can leave multi-TNLA instance (state=‘disabled’) as-is during a C-plane computer unit restart. Once the C-plane computer unit (e.g., CP node) is restarted the TNLA configuration in a Linux kernel IP stack is lost. The resilient FlAP can however restore the TNLA context information and use fast association restart (as per RFC 4960) to recover it transparently with gNB-CU. When the TNLA is recovered in the C-plane computer unit to state=‘disabled’, FlAP in the gNB-DU 124A can change its state with the gNB-CU from ‘disabled’ back to ‘enabled’ again using DU configuration update procedure.

Note: when multi-TNLA instances are initially added for scaling the F1-C link capacity, their TNLA resource state is set to ‘enabled’ by default.

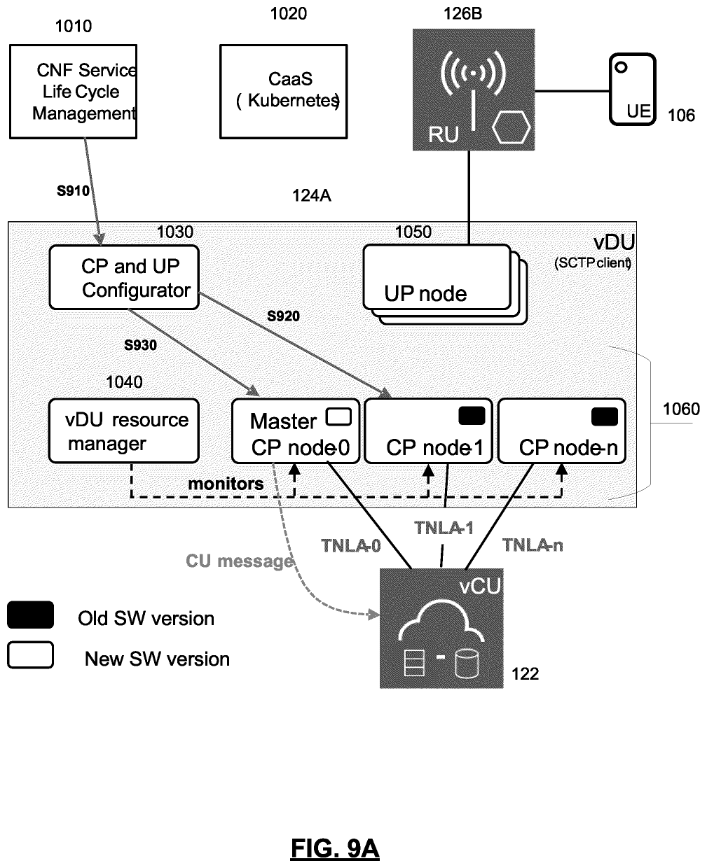

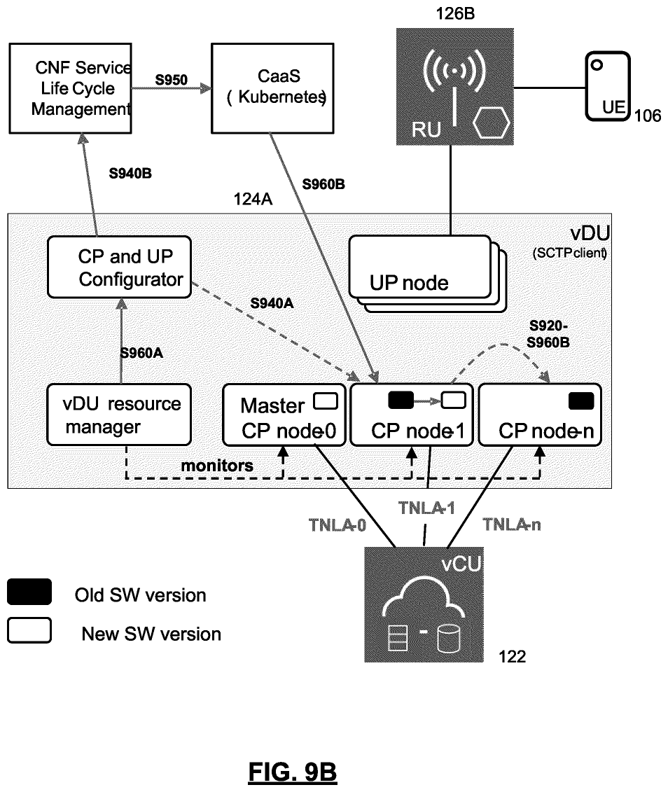

FIG. 9A is a diagram for explaining an example of network preparation for a control plane (C-plane) computer software (SW) upgrade, according to at least some example embodiments. FIG. 9B is a diagram for explaining an example of activating a C-plane computer SW upgrade, according to at least some example embodiments. FIGS. 9A and 9B illustrate the same elements as FIG. 5A. Accordingly, for the purpose of simplicity, a duplicated explanation of the elements of FIGS. 9A and 9B is omitted.

Example methods of preparing a network for a control plane (C-plane) computer software (SW) upgrade and activating a C-plane computer SW upgrade will now be explained with reference to FIGS. 9A and 9B.

In operation S910, the CNF service life cycle management node 1010 notifies the vDU CP and UP configurator 1030 to start a C-plane SW update/upgrade pre-work operation that prepares a C-plane node (e.g., one of CP nodes 1060) duplicated space for a non-disruptive SW upgrade procedure. The SW upgrade can be conducted in accordance with a chosen upgrade policy, e.g., “blue-green upgrade,” “rolling upgrade,” or “canary upgrade”. According to at least some example embodiments, the upgrade policy may be selected by an operation of the wireless communications system 100.

In operation S920, the CP and UP configurator 1030 may prepare the selected next CP service node (i.e., first CP node duplicated space, CP node-1) for a rolling SW upgrade procedure where the selected next CP service node, first CP node CP node-1, is first passively emptied (drained) from all active UE context service data and resources. According to at least some example embodiments, the first CP node, CP node-1 may deny servicing for new RRC connection requests from UEs.

In operation S930, a master FlAP entity associated with the blocked CP node sends a configuration update message GNB_DU_CONFIGURATION_UPDATE to the corresponding FlAP entity in the gNB-CU 122 in order to trigger the active emptying of all existing UE signaling connections gracefully from first TLNA, TNLA-1 and rebalancing the existing UE signaling to other TNLAs in accordance with TNLA load rebalancing rules determined, for example, by the gNB-CU 122.

According to at least some example embodiments, with respect to the RAN preparation-based method:
A vDU-sent DU configuration update message has new IE for identifying the TNLA ID to be disabled and forcefully emptied of all active UE signaling connections by the corresponding FlAP entity of the vCU 122.
A vDU-sent DU configuration update message may have a new IE for providing the TNLA load rebalancing rules to be applied by the FlAP entity of the vCU 122 for the active UE signaling connections be removed from the TNLA ID.

In operation S940, according to at least some example embodiments, when a preparation phase ends, the CP and UP configurator 1030 requests the FlAP entity of the vCU 122 to remove the first TNLA, TNLA-1, which was terminated in the first CP node, CP node-1.

Once the SW upgrade preparation for the first CP node, CP node-1, is completed, the CP and UP configurator 1030 notifies the CNF life cycle management node 1010 about the readiness of the first CP node, CP node-1, to undergo a SW upgrade procedure. At this point, the first CP, CP node-1 is empty from any UE signaling connections and can be gracefully restarted.

In operation S950, the CNF service life cycle management node 1010 then requests a new SW version activation for the CP node-1 from the service orchestrator, CaaS 1020.

In operation S960, the CaaS 1020 will consequently perform the requested new SW version activation for the first CP node, CP node-1. The upgraded SW may be activated by restarting the first CP node, CP node-1. The vDU resource manager 1040 that monitors the availability of CP nodes (e.g., CP nodes 1060) will notify the CP and UP configurator 1030 with respect to changes in the readiness of the first CP nodes, CP node-1. Once the first CP node, CP node-1, becomes ready again after restarting, the CP and UP configurator 1030 can add new multi-TNLA instance to it.

According to at least some example embodiments, the SW upgrade procedures will be repeated one by one for every CP node until all of CP nodes 1060 have the new SW version upgrade activated.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided above to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

As discussed herein, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at, for example, existing UE, base stations, eNBs, RRHs, gNBs, femto base stations, network controllers, computers, Central Units (CUs), ng-eNBs, other radio access or backhaul network elements, or the like. Such existing hardware may be processing or control circuitry such as, but not limited to, one or more processors, one or more Central Processing Units (CPUs), one or more controllers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUs), one or more microprocessors, one or more Application Specific Integrated Circuits (ASICs), or any other device or devices capable of responding to and executing instructions in a defined manner.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium,” “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine-readable mediums for storing information. The term “computer readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks. For example, as mentioned above, according to one or more example embodiments, at least one memory may include or store computer program code, and the at least one memory and the computer program code may be configured to, with at least one processor, cause a network element or network device to perform the necessary tasks. Additionally, the processor, memory and example algorithms, encoded as computer program code, serve as means for providing or causing performance of operations discussed herein.

A code segment of computer program code may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable technique including memory sharing, message passing, token passing, network transmission, etc.

The terms “including” and/or “having,” as used herein, are defined as comprising (i.e., open language). The term “coupled,” as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

According to example embodiments, UEs, base stations, eNBs, RRHs, gNBs, femto base stations, network controllers, computers, central units (CUs), ng-eNBs, other radio access or backhaul network elements, or the like, may be (or include) hardware, firmware, hardware executing software or any combination thereof. Such hardware may include processing or control circuitry such as, but not limited to, one or more processors, one or more CPUs, one or more controllers, one or more ALUs, one or more DSPs, one or more microcomputers, one or more FPGAs, one or more SoCs, one or more PLUs, one or more microprocessors, one or more ASICs, or any other device or devices capable of responding to and executing instructions in a defined manner.

Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

1-30. (canceled)

31. A user equipment (UE) comprising:
memory storing computer-executable instructions; and a processor configured to execute the computer-executable instructions, wherein the computer-executable instructions include:
receiving, from a first network element including a control plane node, a first message indicating that a control plane service provided by the control plane node has stopped;
receiving a first indication that a conditional resume function of the UE has been activated;
receiving a second message indicating that the control plane service has resumed; and
based on the first indication,
in response to the second message, performing the conditional resume function by sending, to the first network element, a first request to reconnect to the control plane node.

32. The UE of claim 31, wherein the instructions further include:
after receiving the first message and before receiving the second message, continuing one or more existing uplink (UL) and/or downlink (DL) transmissions of user plane data between the UE and the first network element using at least one user plane service provided by at least one user plane node of the first network element.

33. The UE of claim 31, wherein the first network element is a next generation node B (gNB) or a distributed unit (DU) of a gNB.

34. A user equipment (UE) comprising:
memory storing computer-executable instructions; and a processor configured to execute the computer-executable instructions, wherein the computer-executable instructions include:
receiving, from a first network element including a control plane node, a first message indicating that a control plane service provided by the control plane node has stopped,
the UE being attached to a first cell associated with the first network element and the control plane node;
receiving a first indication that a conditional redirection function of the UE has been activated;
based on the first indication,
determining, based on first redirection conditions, whether to perform a redirection operation; and
in response to determining to perform the redirection operation, performing the conditional redirection function by attaching to a second cell different from the first cell.

35. The UE of claim 34, wherein the determining includes determining, based on the first redirection conditions, whether the UE requires access to a control plane service.

36. A network element comprising:
memory storing computer-executable instructions; and a processor configured to execute the computer-executable instructions, wherein the computer-executable instructions include:
receiving, from a first user equipment (UE), a UE capability message indicating that the first UE is capable of performing a conditional resume function;
sending, to the first UE, a first message indicating that a control plane service provided by a control plane node of the network element has stopped;
activating the conditional resume function at the first UE by sending the first UE a first indication that the conditional resume function of the UE has been activated;
sending, to the first UE, a second message indicating that the control plane service has resumed; and
receiving, from the first UE, a request to reconnect the first UE to the control plane node.

37. The network element of claim 36, wherein the instructions further include:
after sending the first message and before sending the second message, continuing one or more existing uplink (UL) and/or downlink (DL) transmissions of user plane data between the network element and the first UE using at least one user plane service provided by at least one user plane node included in the network element.

38. The network element of claim 36, wherein the network element is a distributed unit (DU) of a next generation node B (gNB).
